(19) United States
(12) Patent Application Publication
(10) Pub. No.: US 2005/0198881 A1
(43) Pub. Date: Sep. 15, 2005

(54) DFI-daily food intake bracelet (food counter)

(76) Inventor: Angela Catherine Nagy, Oshawa (CA)

Correspondence Address: ANGELA NAGY;#408, 560 Bloor St. E, Oshawa, ON, L1H 3N2, CA

(21) Appl. No.: 11/065,096

(22) Filed: Feb. 25, 2005

(30) Foreign Application Priority Data
Feb. 25, 2004 (CA) 2,458,583

(51) Int. Cl. G09F 3/18

(52) U.S. Cl. 40/642.02

(57) ABSTRACT

A bracelet for calculating food choices is formed by a plurality of food squares that represent a food category and record daily food choices there through. A top cover opens in a revealing manner to expose the functioning part that is underlying. Using this configuration the food squares that represent a food category are in the start position hence, the unconsumed row that is parallel to the start row, therefore indicating the wearer of food eaten and also indicating food that needs to be eaten due to the fact of food squares remaining in the start row. This way the food squares are visual and can be kept track of through the day. The food squares are divided into 5 categories, protein, carbohydrates, fruit, vegetables and dairy. According to an individual needs they will assign themselves numerous food squares of each category to their particular nutritional daily needs. The method of having the food squares all in the start row in the beginning of the day and as the day progresses and food is eaten. The food squares representing that category are moved to the consumed row, over the course of the day. The food squares are then moved back to their original position to begin tracking the next day.

### BACKGROUND OF THE INVENTION

1. Field of the Invention

This invention relates to monitoring the category and quantity of food consumed during a given period of time and more particularly conforming to a pre-determined diet and recording quantities of such food consumed.

2. Description of the Background

Making healthy food choices daily can be difficult. There are outlined guidelines provided to all in the form of a food pyramid guide that the health department provides to the public. This guide has listings of food categories and quantities one must consume on a daily basis to get their proper nutritional needs met. For example, an adult must consume 2-3 servings of protein daily, 5-10 servings of fruit and vegetables, 3-5 servings of carbohydrates and 2-3 servings of dairy products daily. The dieter may find themselves overwhelmed due to the numerous amount of food they must consume, that is outlined by the food pyramid. Children also have the burden of conforming to this food pyramid standards daily. In either case, the dieter may not be able to keep track of the diet consistently.

I have invented a food counter which displays the categories and quantities of food that can be consumed throughout a day and conform to an individuals pre-determined diet. The counter records food choices that are consumed during the day and moreover, as food is consumed the counter displays the balance of the categories of food that can be consumed in that day. Thus at any given time of the day, the dieter can refer to the counter and assess what categories of food they can eat and in what quantities remain of that day in order to conform to the specified diet. The dieter will find it easy to follow this visual accompaniment and will not be obliged to follow a specific menu in order in doing so. The counter is a simplistic approach to eating well and making proper nutritional choices, there is no calorie counting. Moreover, the dieter can use the counter in conjunction with any other dietary program or aid.

### SUMMARY OF THE INVENTION

It is therefore, the food counter of my invention displays the names of food to be consumed in a given period and by quantity in order to conform to a diet, thereby facilitating the process of tracking the food choices daily. This device encourages healthy eating among all particularly school aged children whose obesity rate has risen. The counter comprises: a cover, plurality of food square labels each setting out the name of a category of food in a pre-determined quantity.

The labels are combined in a row to display the total food to be consumed in a day by category and by quantity in order to conform to the diet. A cover is associated with the counter it protects and conceals the food labels. The cover can be positioned closed and open to reveal the underlying contents of the functioning face where the food squares are positioned. This invention functions in a way that a starting position of the labels is set forth on the start row and them parallel to that row is the consumed row. The user then places the correct label representing a food category on the consumed row, after it had been eaten. The food counter's cover can have different and various designs and styles thus being fashionable and giving no outward indication of dieting.

### BRIEF DESCRIPTION OF THE DRAWINGS

The food counter of the invention is described with reference to the accompanying drawing in which:

FIG. 1 is a front perspective of the food counter bracelet.

FIG. 2 is a plain view of the cover in a open revealing manner of the functioning face part of the food counter.

FIG. 3 is a enlarged view of the face displaying the food square labels that represent a food category.

### DETAILED DESCRIPTION OF THE PREFERRED EMBODIMENTS

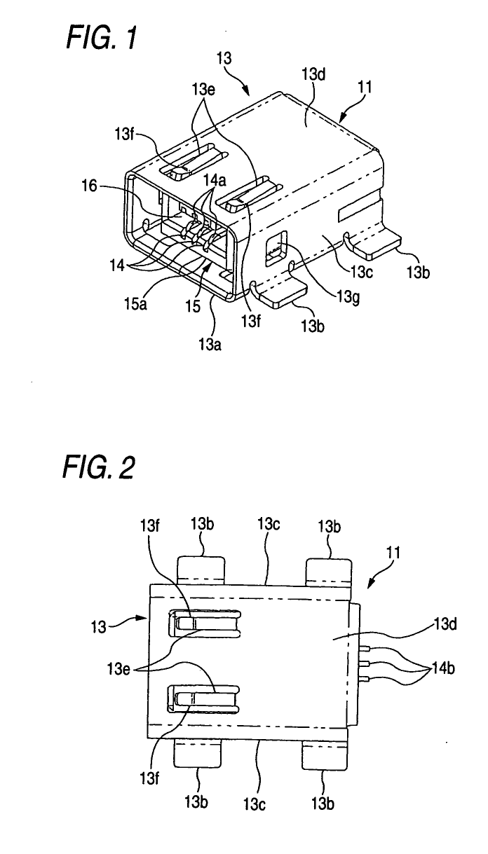

FIG. 1 is a front perspective of a 10 food counter bracelet on which the cover conceals the underlying part. Shortcomings of other dieting aids are tedious and bothersome. Most, people do not want conflicts when dieting, let alone wear an unattractive indicator for dieting. In contrast according to the present bracelet this invention is highly attractive and comfortable to wear. The bracelet is made out of fabric therefore making it very comfortable to wear, also this bracelet can be 12 designed and patterned to an individuals preference. Different colours, Disney patterns and symbolic patterns can all represent this invention thus forth making this invention aesthetically pleasing.

FIG. 2 is a front perspective view of the invention with the 14 cover in an open position. The cover is secured by 16 Velcro which enables easy access to lift the cover up at any time, only one end of the cover is removable. The food counter of the invention generally has 12-15, 18 labels arranged on it. On each label is displayed a name of a 20 food category.

The categories of food are as follows:
Category of Food
Protein
Vegetable
Fruit
Dairy
Carbohydrate

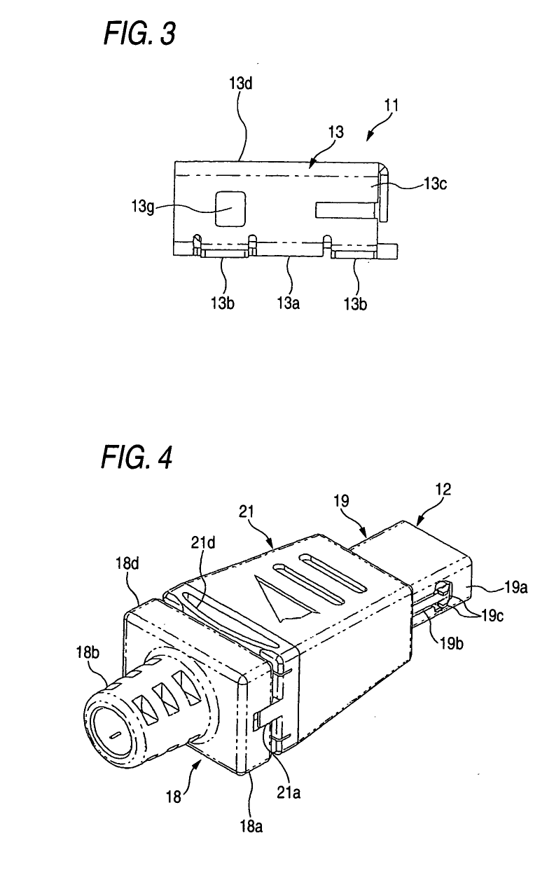

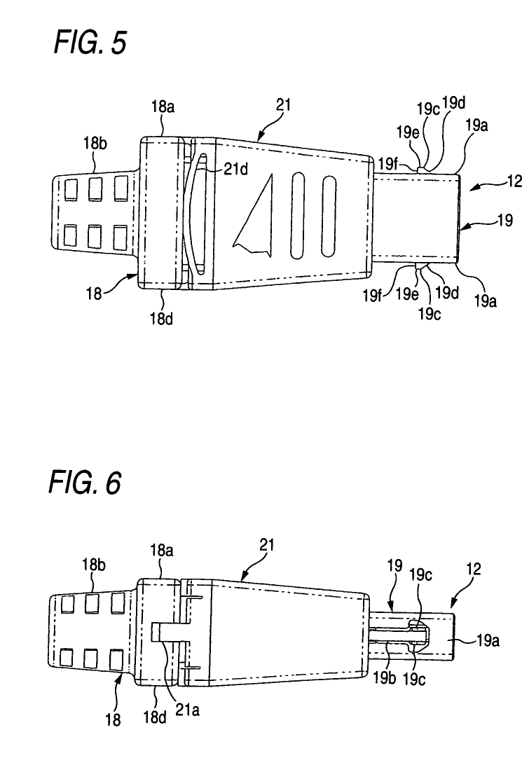

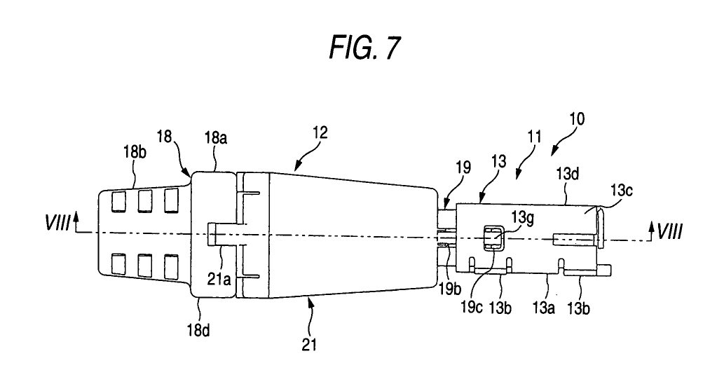

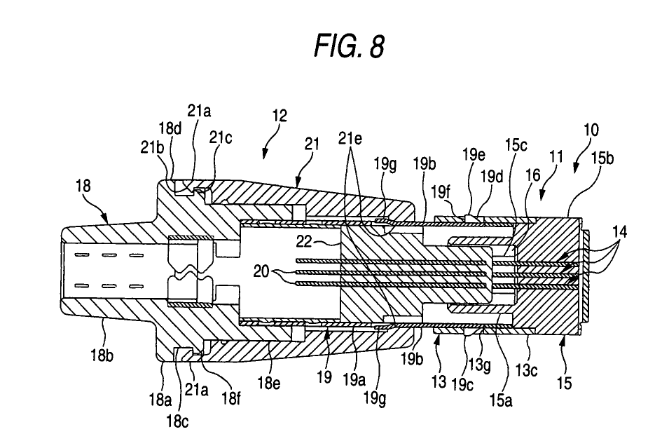

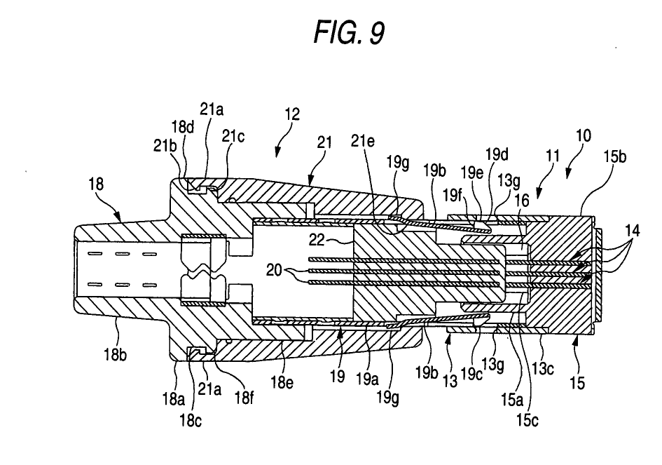

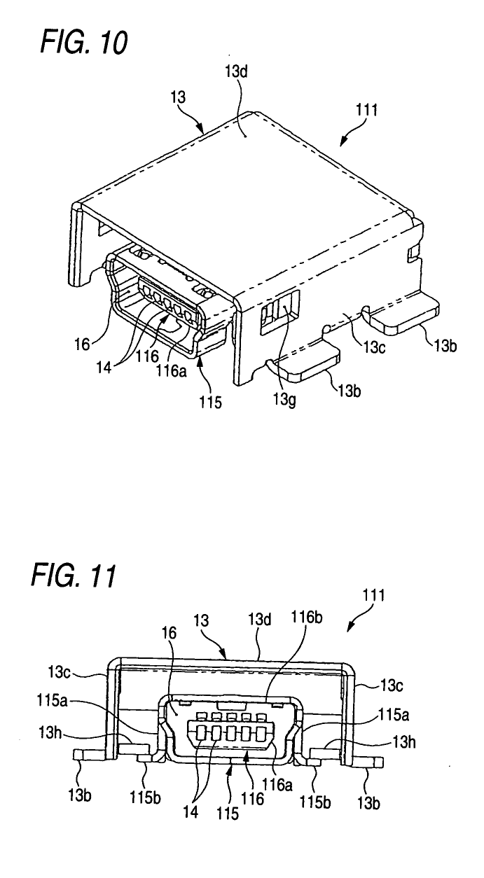

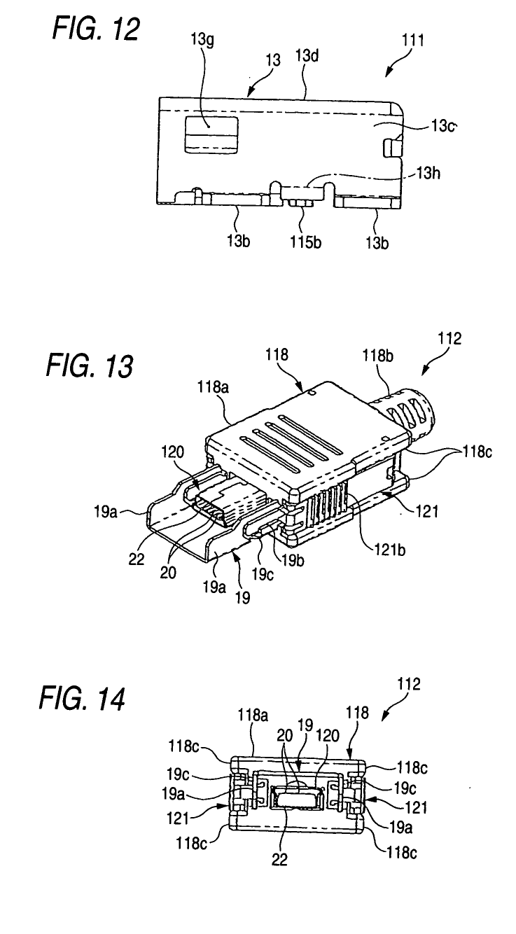

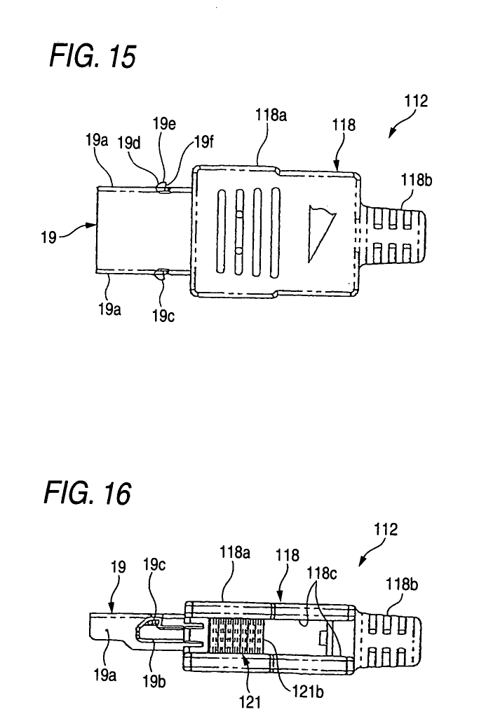

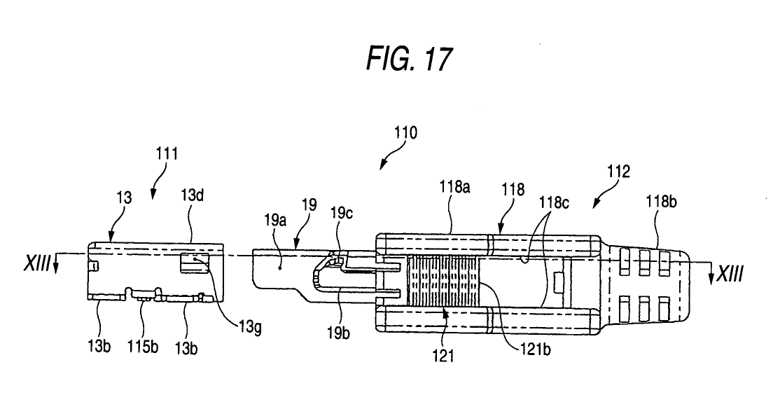

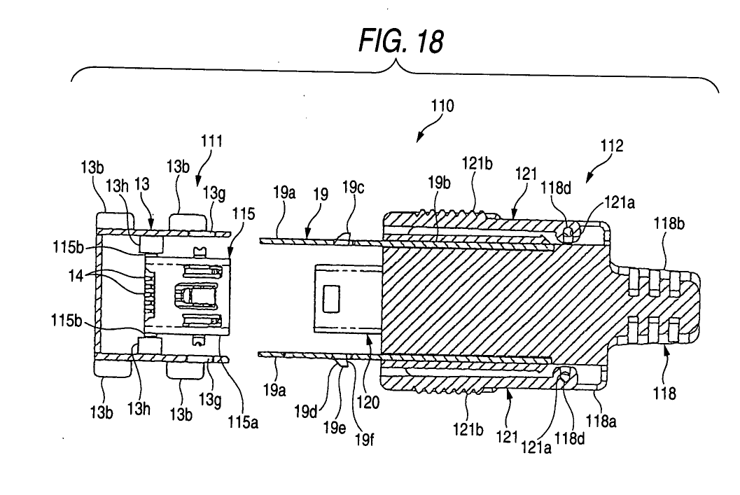

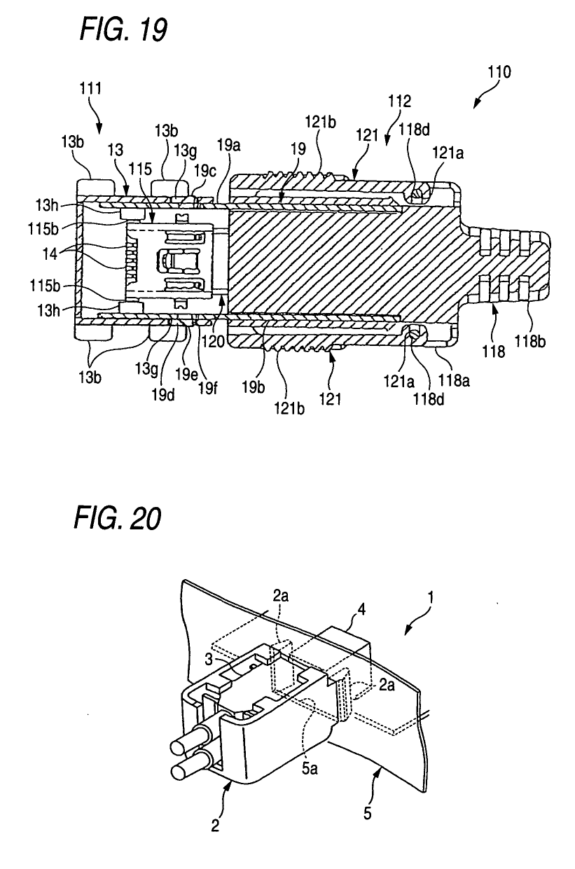

FIG. 3 The face of the food counter bracelet is shown in detail. The 18 food square labels that display the 20 food categories are positioned on the 22 start row which consists of Velcro. As food is consumed the food squares are removed and placed on the parallel row, the 24 consumed row which is made of Velcro. Numerous amounts of food squares representing a food category can have a custom amount for various diets. Should for example the user of the food counter wish to follow a diet that will provide him/her with sufficient daily nutrients, their food labels would be as follows:

| Number of quantity | Food represented by label |
|---|---|
| 3 | Protein |
| 3 | Fruit |
| 4 | Vegetables |
| 2 | Dairy |
| 4 | Carbohydrate |

A typical meal for an entire day that would incorporate these food choices would be:

| Breakfast | Foods Eaten | Food labels & Quantities |
|---|---|---|
| | 2 eggs | 1 protein label |
| | 1 slice of bread | 1 carbohydrate label |
| | 1 apple | 1 fruit label |

So for breakfast 1 protein, 1 carbohydrate and 1 fruit 18 label will be moved to the 24 consumed row.

| Lunch | Foods Eaten | Food labels & Quantities |
|---|---|---|
| | 1 baked chicken | 1 protein label |
| | 2 cups of tossed salad | 2 vegetable labels |
| | 1 cup of pasta | 1 carbohydrate label |

For lunch the user will move 1 protein, 2 vegetable and 1 carbohydrate 18 labels to the 24 consumed row. The user can now asses on the food counter the remaining amount of food squares left so they can regulate their eating by adding more or less food for the remainder of the day.

| | | |
|---|---|---|
| Dinner | Foods Eaten | Food labels & Quantities |

| | |
|---|---|
| Fish fillet | 1 protein label |
| glass of milk | 1 dairy label |
| baked potato | 1 vegetable label |
| 1 cup of green beans | 1 vegetable label |
| 1 dinner roll | 1 carbohydrate label |

The user also had two snacks during the day which consisted of yogurt equalling 1 dairy 18 label that was moved to the 24 consumed row and a bowl of strawberries with kiwi that equalled 2 fruit labels that were moved to the consumed row.

According to the goal set by the individual on the food counter they have eaten all the food required of them, thus making this invention a success. Serving sizes are an individuals choice, this invention does not supply suggested amounts of servings but the food guide pyramid which this invention makes reference to does. It would be in the~best interest of the individual to refer to this guide for guidance in serving sizes.

At any time during the day the user would know how much food they had already consumed and how much more they can consume in the remainder of the day. The food counter would assist the consumer in pacing the eating times and quantities of food consumed so that at the end of the day no more or no less food was consumed that was intended. Based on the user's diet, they have consumed all quantities of the named food squares and now the food squares at the end of the day would have been all moved to the consumed row indicating and individuals success for that day. Having now fully set forth the preferred embodiments it will be understood that modifications can be made in the structure of the food counter of the invention without departing from the scope and pure view of the invention.

1. a device for counting food choices, comprising:
a plurality of labels each setting the name of a category of food in a pre-determined quantity. Said labels combined in such a way that displays the total food to be consumed in a pre-determined period of time by category and by quantity in order to conform to the diet.
a cover associated with the device is movable between open and closed position, the cover protects the food labels.
The food labels are positioned in the start rows, as food is being consumed the labels are moved to the consumed row permitting the wearer to keep track of food choices by the movement of labels from the start row to the consumed row.

2. The food counting device according to claim 1, wherein said a moveable cover.

3. The food counting choices device according to claim 1, wherein said row and a consumed row is where the said labels are positioned.

4. A device that helps individuals meet their daily nutritional needs.
